(19) United States
(12) Patent Application Publication
(10) Pub. No.: US 2005/0186319 A1
(43) Pub. Date: Aug. 25, 2005

(54) Method and composition for fortifying a single serving prepared beverage having minimal nutritional value

(75) Inventors: Ronald K. Williams, Orem, UT (US); Jacque N. Butler, Draper, UT (US)

Correspondence Address: THORPE NORTH & WESTERN, LLP., 8180 SOUTH 700 EAST, SUITE 200, P.O. BOX 1219, SANDY, UT, 84070, US

(73) Assignee: ForMed, Inc.

(21) Appl. No.: 10/783,219

(22) Filed: Feb. 20, 2004

(51) Int. Cl. C12C 1/00

(52) U.S. Cl. 426/590

(57) ABSTRACT

A method is provided of fortifying a single serving prepared beverage having minimal nutritional value with one or more nutritional supplements. The method includes the step of providing a supplement base. A further step is combining nutritional supplements into the supplement base to form a nutritional composition. The nutritional composition can be packed into a single serving dispenser. Another step is combining the nutritional composition from the single serving dispenser with the single serving beverage having minimal nutritional value for personal consumption.

### FIELD OF THE INVENTION

The present invention relates generally to fortifying a single serving prepared beverage.

### BACKGROUND

Many consumer health advocates and mass media writers have continued to point out the unhealthy elements in American culture. There are many easy targets in this finger pointing exercise, such as fast food, a proliferation of pre-prepared food products, the reduced time for meal preparation, the extensive marketing of sodas, the lack of exercise and similar health risks.

Even with the unhealthy food and diet options that are so readily available, there are many individuals who are interested in personal and family health. In recent years, there has been a certain segment of the population in which the interest about health has actually increased. Even some individuals who are less interested in health issues wish they lived a healthier lifestyle.

Examples of this desire for improved health are reflected in the overall interest in vitamins, health foods supplements, and exercise equipment. Some of America's food chains with the strongest recent growth are stores that supply healthy products such as whole foods, organic food, and food supplements. Many shopping malls have one or more vitamin and health supplement stores. In addition, a wide variety of exercise machines can be purchased through large retail chains, exercise boutiques, and other marketing channels. Even at fast food restaurants, “healthier” menu items or even vegetarian items have begun appearing on the menu (e.g. salads, veggie burgers, etc.).

Despite the movement toward more healthy living, many individuals enjoy drinking beverages that have minimal nutritional value. Examples of beverages that have minimal nutritional value are drinks such as tea, coffee, hot chocolate, and soda. None of these beverages provides a significant amount of nutrition to the person drinking the beverage and some scientific studies have pointed to possible health risks for these drinks.

However, these types of drinks with minimal nutritional value are a part of the fabric of society. The local coffee house has long been a place for groups to relax or meet and discuss ideas about art, politics and society. Many people are accustomed to having a morning cup of coffee to start out their day. Tea is heavily ingrained in some societies as a ritual. For instance, the Japanese have ritualized tea drinking and the British have a tradition of afternoon tea.

In addition, to the beverages with minimal nutritional value that have existed for centuries, marketers have introduced even more beverages with minimal nutritional value in the last century. Examples of such beverages are soda, cola, and similar “sport drinks.” Other examples of recently developed drinks with minimal nutritional value are blended drinks such as cappuccinos, caffe lattes, mochas, and other combination type drinks based on coffee, tea or hot chocolate. Most people who enjoy tea, coffee, or sodas do not want to give up these beverages even though they have minimal or even negative nutritional value. Some reasons that consumers may not want to give up drinking these drinks are social customs, personal habits, or their desire for flavorful drinks.

### SUMMARY OF THE INVENTION

The invention provides a method of fortifying a single serving prepared beverage having minimal nutritional value with one or more nutritional supplements. The method includes the step of providing a supplement base. A further step is combining nutritional supplements into the supplement base to form a nutritional composition. The nutritional composition can be packed into a single serving dispenser. Another step is combining the nutritional composition from the single serving dispenser with the single serving beverage having minimal nutritional value for personal consumption.

Additional features and advantages of the invention will be apparent from the detailed description which follows, taken in conjunction with the accompanying drawings, which together illustrate, by way of example, features of the invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention provides a method of fortifying a single serving prepared beverage having minimal nutritional value with one or more nutritional supplements. Particularly, the use of nutritional supplements in a beverage additive allows an individual who will be drinking the single serving prepared beverage to combine fresh additives to the hot or cold beverage. As discussed previously, many individuals desire to be healthier, but the drinks which they frequently consume are not necessarily conducive to that desired health. Thus, the method of the present invention allows an individual to compound nutritional compositions into their single serving beverage at the point of purchase of the single serving beverage.

The method includes a step of providing a supplement base. This supplement base may be a liquid, powder, or solid and can consist of edible bases known to those skilled in the art. For example, vegetable extracts, fruit extracts, or dairy bases can be used. A liquid base can be used by packing it into a fractional ounce container up to a multiple ounce serving size container. When a powder is used as a supplement base, then dry granulated bases can be used. Solids can also be used in forms such as tablets with effervescent material.

A further step is combining nutritional supplements into the supplement base to form a nutritional composition. Nutritional supplements are generally defined as those herbs, vitamins, and compounds that are believed to have health improving qualities that can be added to the supplement base. The nutritional composition can then be packaged into a single serving dispenser. For example, the single serving dispenser may be a bulk dispenser that has a single serving dispensing meter in the lid or a single serving container that is sized to include only one serving in the dispensing container. In the case of a one-use container, various sized small serving containers can be used with a peelable lid sealed over the dispenser top. These single or multiple serving dispensers can then be located at a location where the nutritional composition is to be combined with the single serving prepared beverage.

A further step is combining the nutritional composition from the single serving dispenser with a single serving beverage having minimal nutritional value for personal consumption. This may include pouring the liquid nutritional compound into the prepared beverage when it is purchased, mixing a powder that is poured into the beverage, or waiting for tablets to dissolve in a beverage.

Combining the nutritional composition into the single serving prepared beverage at the time the beverage is purchased or at the point-of-sale provides certain benefits. One particular benefit is that the ingredients of the nutritional composition will not be stored in formulation with the drink. This preserves the bioactive stability of the nutritional composition. Combining the nutritional composition with the prepared beverage in advance of the purchase of the beverage may cause the nutritional compositions to break down in the drink. For example, some nutritional compounds contain anti-oxidants and similar health promoting compositions which may be destroyed by lengthy storage in a water-based compound. Thus, the present invention enables the consumer to add the nutritional composition to the beverage just before the beverage is consumed in order to obtain the maximum health benefits of the nutritional composition. Another benefit of this method is that additional stabilizing compounds do not generally need to be added to the nutritional composition to preserve the nutritional composition when mixed into the beverage. This is possible because the beverage is intended to be consumed within a short period of time after the nutritional composition has been added.

An example of how the present invention may be used will now be described. The single serving beverage, having minimal nutritional value, can be a beverage such as coffee, tea, hot chocolate, or soda. The beverage will generally be intended for personal consumption at the point where it is purchased and thus the beverage will already be prepared at the establishment selling the beverage. The individual who will be personally consuming the beverage can purchase the single serving prepared beverage at a location such as a coffee shop, fast food restaurant, convenience store, or a similar food establishment. Then the individual drinking the beverage can obtain and purchase the nutritional composition at or near the place where he or she is purchasing the single serving prepared beverage. For instance, small containers with the nutritional composition may be purchased in conjunction with the single serving beverage. Alternatively, the single serving dispenser may be in close proximity to the place where the single serving beverage is purchased and the individual drinking the beverage (or a retail clerk) can meter out an amount of the nutritional composition for the single serving.

In one embodiment of the invention, the nutritional composition can be a coffee creamer that is provided to be combined with the single serving prepared beverage. Health promoting coffee creamer ingredients can also be included in the creamer. For example, nondairy creamer ingredients may be organically grown or the sweeteners used in the creamer may be in a raw sugar form. If a dairy creamer is used, it may be a high quality dairy creamer that is an organic cream from animals which are not administered hormones and are range fed.

The single serving beverages discussed herein are generally considered as having minimal nutritional value. Typically drinks such as coffee, tea, hot chocolate, or soda are not considered to have any significant nutritional value from the point of view of increasing health, growth, or bodily well being. As such, individuals in the past have simply consumed these drinks and have realized that there were generally no significant nutritional benefits provided in conjunction with these drinks. The consumption of these drinks was simply considered habitual, ritualistic, personal choice, or social. By using the present invention, those who consume these drinks can receive health-promoting compositions along with these drinks.

A drink such as coffee has comparatively little nutritional value contained in it. When an individual consumes a coffee extract which is brewed or boiled (as compared to consuming the roasted coffee bean itself), the contents of the drink are about 98.5% water with 0.4% carbohydrates and 0.1% protein. The energy value is roughly 8 kilojoules or 2 kilocalories. Although there is some fat in the coffee oil, the large majority of the coffee oil remains in the coffee grounds. The tiny amount of oil that can be seen in the film on the surface of a coffee cup contributes a negligible amount to the energy in the person consuming the drink. Some varieties of coffee contain up to 1% caffeine and this caffeine is not generally considered to have any particular health promoting effect and may in fact have some detrimental effects.

Another group of drinks that have minimal nutritional value are sodas, which include carbonated beverages such as Coca-Cola, Dr. Pepper, Sprite, Diet Coke, Root Beer, Mt. Dew, Pepsi, and other highly sweetened drinks. Examples of other types of non-carbonated soda water are water ices such as snow cones, Slurpees®, slushies, etc. In contrast, water ices or soda water do not include drinks made with fruit juices that generally are considered to have a larger relative amount of nutritional value.

The present invention benefits those who drink beverages such as coffee, tea, hot chocolate, and sodas by providing high quality, flavored or unflavored nutritional compositions for the beverages. When creamers are added to coffee or tea using the present invention, they are generally nondairy creamers which are lactose free and organic. Dairy based creamers can also be used with the nutritional compositions if desired.

There are many different compositions of nutritional supplements that can be provided and added to beverages with minimal nutritional value in the manner described above. Listed below are some ingredients and compositions that can be included in nutritional supplements with the intent of improving a person's health in a certain area.

| COMPOSITION | INGREDIENTS |
|---|---|
| SLEEP | Melatonin |
| | L'Theanine |
| CHOLESTEROL | Policosanols |
| BRAIN | Vinpocetine |
| | Ginkgo Biloba |
| | L-Arginine |
| | Acetyl-L-Carnitine |
| BONE | Coral Calcium |
| | Magnesium |
| | Vitamin K |
| | Boron |
| SKIN | Calcium |
| | Chromium |
| | Selenium |
| | Zinc |
| | Ascobyl Pulminate |
| | Magnesium |
| | L-Carnitine |
| | N-Acetyl-L-Carnitine |
| | L-Glutamine |
| | Collagen Hydrolysate |
| | Tumeric |
| | DMAE |
| | Green Tea |
| | Grape Seed |
| | Alpha Lipoic Acid |
| | COQ10 |
| DIGESTIVE | Amylase |
| | Protease |
| | Lipase |
| | Cellulose |
| | Pectin |
| | HCL |
| | Sucrase |
| | Maltase |
| | Lactase |
| ENERGY | B-Complex |
| | Ginseng |
| | Ginkgo Biloba |
| HORMONE | DHEA |
| | Pregnenolone |
| | Melatonin |
| WEIGHT LOSS | Vitamin C |
| | Vitamin E |
| | Thiamin |
| | Riboflavin |
| | Niacinamide |
| | Pyridoxine Hydrochloride |
| | Biotin |
| | Chromium |
| | Molybdenum |
| | Garcinia Cambogia |
| | Congugated Linoleic Acid (CLA) |
| | Glucosol |
| PROSTATE | Nettle Root |
| | Saw Palmetto |
| | Pygeum |
| | Lysopene |
| JOINT | MSM |
| | Glucosamine |
| | Chondroitin |
| LIVER DETOX | N-Acetyl Cystene |
| | Milk Thistle |
| | Green Tea |
| | Alpha Lipoic Acid |
| | Red Clover |
| MULTIPLE VITAMIN | Vitamin A, C, D3, E, B1, B2, B3, |
| | B6, B12 |
| | Folic Acid |
| | Pantothenic Acid |
| | Biotin |
| | Calcium |
| | Iodine |
| | Magnesium |
| | Zinc |
| | Selenium |
| | Manganese |
| | Chromium |
| | Molybdenum |
| | Potassium |
| | Inositol |
| IMMUNE | Green Tea Extract |
| | Colostrum |
| | Indole 3 Carbonal |
| | Shitake Mushroom |
| | Grapefruit Seed Extract |
| | Beta 1-3 Glucon |
| EYE | L-TAURINE |
| | N-Acetyl Cystene |
| | Alpha Lipoic Acid |
| | Bilberry |
| | Lycopene |
| | Astazanthin |
| | Lutein |
| HEART | Alpha Lipoic Acid |
| | Co-Enzyme Q10 |
| | Grape Seed Extract |
| | Hawthorne Extract |
| | L'Taurine |
| MALE LIBIDO | L-Arginine |
| | Muira Puama |
| | Avena Sativa |
| | Tribulis Terristris |
| | Choline |
| | Ginkgo Biloba |
| FEMALE LIBIDO | Pantothenic Acid |
| | L-Arginine |
| | Muira Puama |
| | Maca Root |
| | Avena Sativa |
| | Dong Quai |
| | Choline |
| | Ginkgo Biloba |
| MOOD | 5 HTP |
| | L-Theanine |
| FEMALE POST MENOPAUSAL | Black Cohash |
| | Dong Quai |
| | Chastertree Berry |
| | Green Tea |
| | Red Clover |
| | Indole 3 Carbinol |
| BODY BUILDER FORMULA | Androstenedione |
| | L-Glutamine |
| | L-Tyrosine |
| | L-Arginine |
| | L-Glycine |
| | L-lysine |
| | Whey Protein |
| ANTIOXIDANT | Vitamin C |
| | Vitamin E |
| | Grape Seed |
| | Alpha Lipoic Acid |
| | Green Tea |
| HANGOVER | Charcoal |
| | Calcium |

The compositions of nutritional supplements described above are illustrative but not limiting. Any number of other supplement compositions can be used in the nutritional compositions that are added to a single serving prepared beverage.

Flavorings can also be added to the nutritional compositions as desired. Many types of coffee flavorings currently exist on the market and flavorings can be included directly with the nutritional compounds or added to the prepared beverage separately. Some examples of flavorings that can be used are cinnamon, maple, almond, hazelnut, vanilla, caramel, raspberry, mint or other flavorings.

In addition to the delivery of nutritional supplements such as vitamins, herbs, and similar healthful ingredients that are not regulated by the government, the nutritional supplements can also be combined with a therapeutically effective amount of therapeutic agents. Alternatively, therapeutic agents can be included in the nutritional composition with just one or even no additional nutritional supplements. The terms “therapeutic agent,” “bioactive agent,” “pharmaceutical,” and “drug” are also used interchangeably and refer to a pharmacologically active substance or composition. These terms of art are well known in the pharmaceutical and medicinal arts.

The phrase “therapeutically effective amount” refers to an amount of therapeutic agent sufficient to achieve therapeutic or adequate supplementation results. The determination of an effective amount is well within the ordinary skill in the art of pharmaceutical, cosmetic, and medical sciences. See, for example, Meiner and Tonascia, “Clinical Trials: Design, Conduct, and Analysis,” Monographs in Epidemiology and Biostatistics, Vol. 8 (1986), incorporated by reference in its entirety.

Specifically, the therapeutic agents being added to the single serving beverage having minimal nutritional value can include what are commonly known as pharmaceutical drugs regulated by governmental agencies. When therapeutic agents are packaged with nutritional supplements, the packaging for the nutritional composition can be in a single serving dispenser that is sold under the private labels of the pharmaceutical company manufacturing the therapeutic agent. Pharmaceutical companies can provide over-the-counter or prescription medications into the nutritional compositions that are combined together with a single serving beverage having minimal nutritional value.

For example, pharmaceutical makers of over-the-counter allergy antihistamines would be able to sell the nutritional compositions in single serving containers where single serving prepared beverages are sold such as at Starbucks, 7-Eleven, gas stations, or other locations where these beverages are sold. The advantage of providing therapeutic agents at the point of sale where these single serving beverages are served is that cafes, restaurants, convenience stores, and other establishments can then sell healthful supplements and/or therapeutic drugs along with their single serving prepared drinks. Instead of a beverage consumer feeling guilty for consuming beverages that do not benefit their body or may even have detrimental effects upon their body, the consumers of these beverages can have an overall increased well-being by consuming these drinks along with the nutritional compositions added from a single serving dispenser.

In addition, consumers of the nutritional compositions or therapeutic agents in a single serving prepared beverage are able to quickly and easily add the nutritional compositions to their drinks. This means the consumer has the choice of how they would like to improve their health and they can do it quickly. Moreover, the retail establishment selling the single serving drinks does not need any special equipment or extra beverage inventory to sell these healthful combinations.

Another benefit of enabling a customer to choose a desired nutritional composition is that the customer can avoid receiving an overdose of particular medicines, vitamins, herbs, therapeutic agents or similar nutritional compositions that the consumer may already be taking. Some consumers may also be allergic to specific types of nutritional compounds. For example, the consumer can avoid vitamin E or acids if the consumer's body cannot tolerate certain nutritional compositions.

The present invention includes a composition for adding nutritional supplements to a beverage with minimal nutritional value. The composition includes a supplement base that may be a liquid, powder, or solid. A nutritional supplement is also included in the composition. The supplement base and the nutritional supplement can be combined with a beverage with minimal nutritional value. Generally, the beverage with minimum nutritional value can be coffee, tea, hot chocolate, or soda. The beverage with minimal nutritional value is prepared for personal consumption at a point of sale. In other words, a third party has prepared the beverage for immediate consumption as soon the person buys the drink. An example of this would be a retail outlet, such as Starbucks, where coffee is purchased for immediate consumption and is brewed by someone other than the person purchasing the drink.

The nutritional supplement and supplement base can be added to the beverage by the person who is going to be consuming the drink. Alternatively, the employee of the retail establishment can add the nutritional composition to the single serving prepared beverage. As discussed before, the supplement base and nutritional supplement can be made from organically grown ingredients, non-dairy products, or other healthful ingredients.

In addition to selling nutritional compositions through retail outlets, these nutritional compositions can be sold in single servings or in bulk through other commercial outlets. For example, the nutritional compositions can be sold wholesale to restaurants, caterers, or direct selling organizations. Marketing through a network marketing or direct selling organization allows the product to be sold to consumers using word of mouth marking techniques. Alternatively, the nutritional compositions can be sold under a private label at nearly any location where beverages with minimal nutrition are sold. For example, private labels can be created for Starbucks, 7-11, etc.

It is to be understood that the above-referenced arrangements are illustrative of the application for the principles of the present invention. It will be apparent to those of ordinary skill in the art that numerous modifications can be made without departing from the principles and concepts of the invention as set forth in the claims.

1. A method of fortifying a single serving prepared beverage having minimal nutritional value with one or more nutritional supplements, comprising the steps of:
providing a supplement base;
combining nutritional supplements into the supplement base to form a nutritional composition;
packaging the nutritional composition into a single serving dispenser;
combining the nutritional composition from the single serving dispenser with the single serving beverage having minimal nutritional value for personal consumption.

2. A method as in claim 1, wherein the step of combining the nutritional composition with the single serving beverage further comprises the step of combining the nutritional composition with the single serving beverage at a point of purchase of the single serving beverage.

3. A method as in claim 1, further comprising the step of including creamer ingredients with the supplement base to form a nutritional composition.

4. A method as in claim 3, further comprising the step of including health promoting creamer ingredients with the supplement base to form a nutritional composition.

5. A method as in claim 3, further comprising the step of including non-dairy creamer ingredients with the nutritional base to form a nutritional composition.

6. A method as in claim 3, further comprising the step of including dairy based creamer ingredients with the supplement base to form a nutritional composition.

7. A method as in claim 1, further comprising the step of providing a supplement base that is selected from group consisting of liquid, powder or solid.

8. A composition for adding nutritional supplements to a beverage with minimal nutritional value, comprising:
a supplement base;
a nutritional supplement; and
a beverage with minimal nutritional value, wherein the beverage with minimal nutritional value is configured for personal consumption.

9. A composition as in claim 8, wherein the beverage with minimal nutritional value is selected from the group consisting of coffee, tea and soda.

10. A composition as in claim 8, further comprising creamer ingredients added to the supplement base.

11. A composition as in claim 8, further comprising non-dairy creamer ingredients in the supplement base.

12. A composition as in claim 8, further comprising dairy based creamer ingredients in the supplement base.

13. A composition as in claim 8, wherein the supplement base and the nutritional supplement are made from organically grown ingredients.

14. A composition for adding nutritional supplements to a beverage with minimal nutritional value, comprising:
a supplement base;
a nutritional supplement containing therapeutic agent; and
a beverage with minimal nutritional value selected from the group consisting of coffee, tea and soda, wherein the beverage with minimal nutritional value is configured for personal consumption.

15. A composition as in claim 14, further comprising creamer ingredients with the supplement base to form a nutritional composition.

16. A composition as in claim 15, further comprising health promoting creamer ingredients with the supplement base to form a nutritional composition.

17. A composition as in claim 15, further comprising the non-dairy creamer ingredients with the nutritional base to form a nutritional composition.

18. A composition as in claim 15, further comprising dairy based creamer ingredients with the supplement base to form a nutritional composition.
